(19) United States
(12) Patent Application Publication
(10) Pub. No.: US 2007/0171955 A1
(43) Pub. Date: Jul. 26, 2007

(54) Cooled mirror dew-point hygrometer

(75) Inventors: Yoshiyuki Kanai, Tokyo (JP); Ken Iwakiri, Tokyo (JP); Masaki Takechi, Tokyo (JP); Shingo Masumoto, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Yamatake Corporation

(21) Appl. No.: 11/473,992

(22) Filed: Jun. 22, 2006

(30) Foreign Application Priority Data
Jan. 20, 2006 (JP) 012291/2006

(51) Int. Cl. G01N 25/02

(52) U.S. Cl. 374/28

(57) ABSTRACT

A cooled mirror dew-point hygrometer includes a thermoelectric cooling element, mirror, light-emitting unit, light-receiving unit, temperature detector, dew-point increase detector, and control unit. The control unit forcibly supplies a current to the thermoelectric cooling element in a direction reverse to a positive direction when the dew-point increase detector detects a rise in dew point.

### BACKGROUND OF THE INVENTION

The present invention relates to a cooled mirror dew-point hygrometer for detecting as a dew point a temperature of a mirror surface in an equilibrium state having no increase/decrease in dew condensation in such a manner that the mirror surface exposed to a measurement target gas is cooled using a thermoelectric cooling element such as a Peltier element and part of steam contained in the measurement target gas is condensed on the mirror surface.

A dew-point detection method is conventionally known as a humidity measurement method. In this detection method, the temperature of a measurement target gas is decreased, part of steam contained in this gas is condensed, and the dew condensation temperature is measured to detect the dew point. For example, the following conventional cooled mirror dew-point hygrometer is known. A mirror is cooled using a freezing medium, freezer, or electronic cooler. A change in intensity of light reflected by the surface of the cooled mirror is detected, and the temperature of the mirror surface is measured. The dew point of the moisture in the measurement target gas is detected.

Such cooled mirror dew-point hygrometers are classified into two types depending on the types of reflected light beams used. One is a regularly reflected light detection scheme using regularly reflected light as disclosed in Japanese Patent Laid-Open No. 61-75235. The other is a scattered light detection scheme using scattered light as disclosed in Japanese Patent Laid-Open No. 63-309846.

[Regularly Reflected Light Detection Scheme]

FIG. 11 shows the main part of a conventional cooled mirror dew-point hygrometer employing the regularly reflected light detection scheme. A cooled mirror dew-point hygrometer 101 comprises a chamber 1 into which a measurement target gas flows and a thermoelectric cooling element (Peltier element) 2 arranged inside the chamber 1. A bolt 4 is fixed to a cooling surface 2-1 of the thermoelectric cooling element 2 through a copper block 3. Heat sink fins 5 are attached to a heating surface 2-2 of the thermoelectric cooling element 2. An upper surface 4-1 of the bolt 4 fixed to the copper block 3 is a mirror surface. A winding temperature measurement resistor (temperature detection element) 6 is buried in the side portion of the copper block 3 (see FIG. 13). A light-emitting element 7 and light-receiving element 8 are arranged in the upper portion of the chamber 1. The light-emitting element 7 obliquely limits light to the upper surface (mirror surface) 4-1 of the bolt 4. The light-receiving element 8 receives light regularly reflected by the mirror surface 4-1 upon emitting the light from the light-emitting element 7. A heat-insulating member 9 is disposed around the thermoelectric cooling element 2.

In the cooled mirror dew-point hygrometer 101, the mirror surface 4-1 in the chamber 1 is exposed to the measurement target gas flowing into the chamber 1. If no dew is formed on the mirror surface 4-1, almost all light emitted from the light-emitting element 7 is regularly reflected and received by the light-receiving element 8. When no dew is formed on the mirror surface 4-1, the intensity of the reflected light received by the light-receiving element 8 is high.

When a current flowing in the thermoelectric cooling element 2 increases to lower the temperature of the cooling surface 2-1 of the thermoelectric cooling element 2, the steam contained in the measurement target gas is condensed on the mirror surface 4-1. Light emitted from the light-emitting element 7 is partially absorbed by the water molecules or irregularly reflected. This decreases the intensity of the reflected light (regularly reflected light) received by the light-receiving element 8. By detecting a change in light regularly reflected by the mirror surface 4-1, a change in state on the mirror surface 4-1, i.e., attaching the moisture (water droplets) on the mirror surface 4-1 can be known.

The current supplied to the thermoelectric cooling element 2, i.e., the current to a positive direction having the surface 2-1 on the mirror 4 side as a low-temperature side and the surface 2-2 on the heat sink fin 5 side as a high-temperature side is controlled on the basis of the amount of reflected light received by the light-receiving element 8 so as to obtain an equilibrium state having no increase/decrease in dew condensation on the mirror surface 4-1, i.e., an equilibrium state having no change in amount of reflected light received by the light-receiving element 8. The temperature detection element 6 measures the temperature of the mirror surface 4-1 at this time. This makes it possible to know the dew point of the moisture in the measurement target gas.

[Scattered Light Detection Scheme]

FIG. 12 shows the main part of a conventional cooled mirror dew-point hygrometer employing the scattered light detection scheme. A cooled mirror dew-point hygrometer 102 has almost the same arrangement as the cooled mirror dew-point hygrometer 101 employing the regularly reflected light detection scheme except the mounting position of a light-receiving element 8. In the cooled mirror dew-point hygrometer 102, the light-receiving element 8 is arranged not at a position where light regularly reflected by a mirror surface 407 upon emitting the light from a light-emitting element 7 is not received, but at a position where scattered light is received.

In the cooled mirror dew-point hygrometer 102, the mirror surface 4-1 is exposed to a measurement target gas flowing into a chamber 1. When no dew is formed on the mirror surface 401, almost all light emitted from the light-emitting element 7 is regularly reflected, and the amount of light received by the light-receiving element 8 is very small. That is, when no dew is formed on the mirror surface 4-1, the intensity of the reflected light received by the light-receiving element 8 is low.

When a current flowing in a thermoelectric cooling element 2 increases to lower the temperature of a cooling surface 2-1 of the thermoelectric cooling element 2, the steam contained in the measurement target gas is condensed on the mirror surface 4-1. Light emitted from the light-emitting element 7 is partially absorbed by the water molecules or irregularly reflected. This increases the intensity of the irregularly reflected light (scattered light) received by the light-receiving element 8. By detecting a change in light scattered by the mirror surface 4-1, a change in state on the mirror surface 4-1, i.e., attaching the moisture (water droplets) on the mirror surface 4-1 can be known.

The current supplied to the thermoelectric cooling element 2, i.e., the current to a positive direction having the surface 2-1 on the mirror 4 side as a low-temperature side and the surface 2-2 on the heat sink fin 5 side as a high-temperature side is controlled on the basis of the amount of reflected light received by the light-receiving element 8 so as to obtain an equilibrium state having no increase/decrease in dew condensation on the mirror surface 4-1, i.e., an equilibrium state having no change in amount of reflected light received by the light-receiving element 8. The temperature detection element 6 measures the temperature of the mirror surface 4-1 at this time. This makes it possible to know the dew point of the moisture in the measurement target gas.

In either of the above cooled mirror dew-point hygrometers, the mirror is cooled by the thermoelectric cooling element 2, but the dew point of the measurement target gas may abruptly increase during the measurement. In this case, when the mirror 4 is kept cooled, the dew point cannot be measured. As shown in Japanese Patent Laid-Open No. 9-307030, the current to the thermoelectric cooling element 2 is cut off, and the measurement is kept stopped until the temperature of the mirror surface 4-1 naturally rises to about the dew-point temperature. The measurement of the dew-point temperature is then restarted.

In a conventional cooled mirror dew-point hygrometer, when the dew point of the measurement target gas abruptly increases during the measurement, the current to the thermoelectric cooling element 2 is cut off, and the restart of the measurement depends on the natural rise of the temperature of the mirror surface 4-1 by the current cut-off from the thermoelectric cooling element 2. Therefore, it takes a long time until the measurement of the dew-point temperature is allowed.

### SUMMARY OF THE INVENTION

The present invention has been made to solve the conventional problem described above, and has as its object to provide a cooled mirror dew-point hygrometer capable of quickly increasing a mirror surface temperature and greatly shortening the waiting time until the measurement of a dew-point temperature when the dew point of a measurement target gas abruptly increases during the measurement.

In order to achieve the above object of the present invention, there is provided a cooled mirror dew-point hygrometer comprising a thermoelectric cooling element having one surface set as a low-temperature side and the other surface set as a high-temperature side upon reception of a current in a positive direction, a mirror mounted on the one surface of the thermoelectric cooling element and having a mirror surface exposed to a measurement target gas, light-emitting means for applying light to the mirror surface, light-receiving means for receiving one of scattered light and regularly reflected light of light emitted from the light-emitting means to the mirror surface, temperature detection means for detecting a temperature of the mirror surface, dew-point increase detection means for detecting a rise of a dew point of the measurement target gas, and control means for controlling the current supplied to the thermoelectric cooling element in the positive direction so as to set an equilibrium state having no increase/decrease in dew condensation on the mirror surface, on the basis of a light reception amount of one of the scattered light and regularly reflected light received by the light-receiving means, wherein the control means forcibly supplies a current to the thermoelectric cooling element in a direction reverse to the positive direction when the dew-point increase detection means detects a rise in dew point.

### BRIEF DESCRIPTION OF THE DRAWINGS

FIG. 1 is a view showing the schematic arrangement of a cooled mirror dew-point hygrometer according to the first embodiment of the present invention;

FIGS. 2A to 2E are views showing arrangements in which optical fibers on the light-emitting side and light-receiving sides are set parallel in a tube;

FIG. 3A is a waveform chart of pulse light irradiating the lower side of a detection surface;

FIG. 3B is a waveform chart of reflected pulse light received from the lower side of the detection surface;

FIG. 4 is a flowchart showing an example of processing for detecting an abrupt increase in intensity of reflected pulse light in a light reception amount abrupt increase detector shown in FIG. 1;

FIG. 5 is a flowchart showing another example of processing for detecting an abrupt increase in intensity of reflected pulse light in the light reception amount abrupt increase detector shown in FIG. 1;

FIG. 6 is a graph showing a change in mirror surface temperature when the dew point of a measurement target gas abruptly increases during the measurement;

FIG. 7 is a view showing a modification of a sensor unit shown in FIG. 1;

FIG. 8 is a view showing the schematic arrangement of a cooled mirror dew-point hygrometer according to the second embodiment of the present invention;

FIG. 9 is a flowchart showing an example of processing for detecting an abrupt decrease in intensity of reflected pulse light in a light reception amount abrupt decrease detector shown in FIG. 8;

FIG. 10 is a flowchart showing another example of processing for detecting an abrupt decrease in intensity of reflected pulse light in the light reception amount abrupt decrease detector shown in FIG. 8;

FIG. 11 is a view showing the main part of a conventional cooled mirror dew-point hygrometer employing a regularly reflected light detection scheme;

FIG. 12 is a view showing the main part of another conventional cooled mirror dew-point hygrometer employing a scattered light detection scheme; and

FIG. 13 is a perspective view showing the structure in which a mirror and temperature detection element are mounted in a conventional cooled mirror dew-point hygrometer.

### DESCRIPTION OF THE PREFERRED EMBODIMENTS

The present invention will be described in detail with reference to the accompanying drawings.

### First Embodiment: Scattered Light Detection Scheme

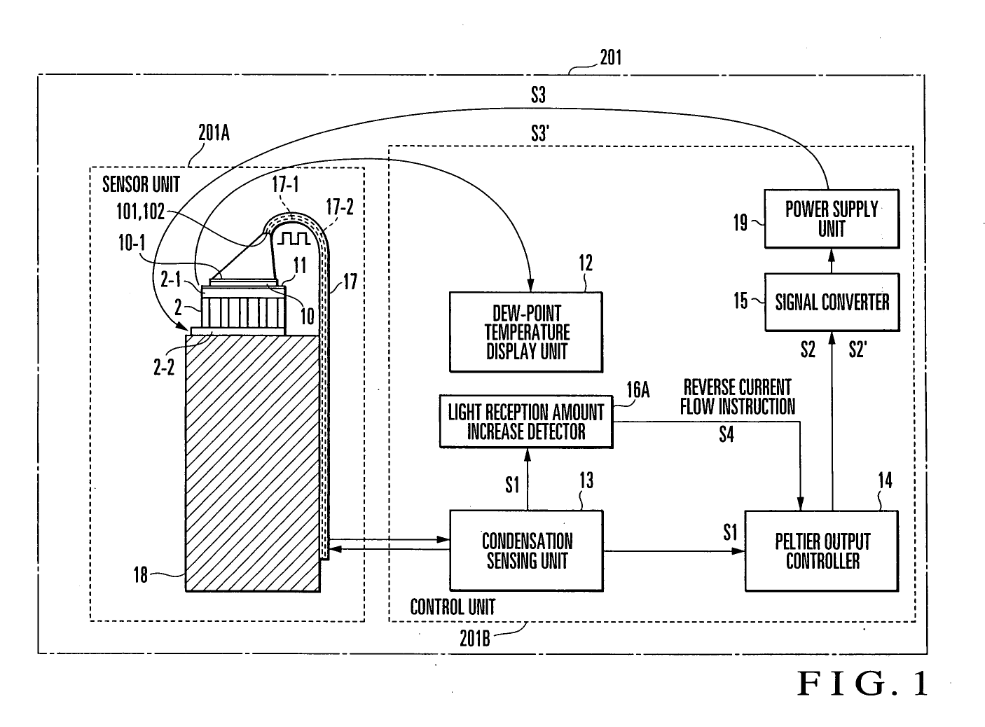

FIG. 1 shows the schematic arrangement of a cooled mirror dew-point hygrometer according to the first embodiment of the present invention. A cooled mirror dew-point hygrometer 201 comprises a sensor unit 201A and control unit 201B.

A mirror 10 is mounted on a cooling surface 2-1 of a thermoelectric cooling element (Peltier element) 2. The mirror 10 is obtained by mirror-finishing a surface 10-1 of a silicon chip. A platinum thin-film temperature measurement resistor (temperature detection element) 11 is formed at the bonding surface between the mirror 10 and the cooling surface 2-1 of the thermoelectric cooling element 2. A columnar heat sink 18 is attached to a heating surface 2-2 of the thermoelectric cooling element 2. A stainless steel tube 17 having a J-shaped upper end portion is disposed along the heat sink 18.

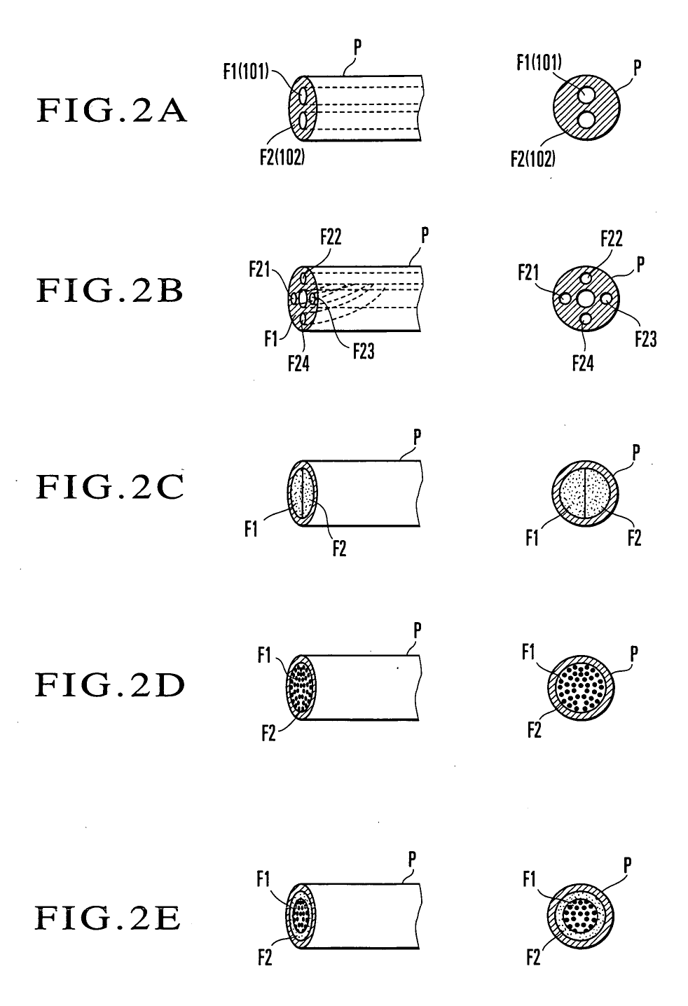

Various types of tubes P accommodating optical fibers shown in FIGS. 2A to 2E can be used as the tube 17. As shown in FIG. 2A, in the tube P, an optical fiber F1 on the light-emitting side and an optical fiber F2 on the light-receiving side are set parallel. The space between the inner wall surface of the tube P and the optical fibers F1 and F2 on the light-emitting and light-receiving sides is filled with a potting material. As shown in FIG. 2B, in the tube P, an optical fiber F1 on the light-emitting (or light-receiving) side is parallel to optical fibers F21 to F24 on the light-receiving (or light-emitting) side. As shown in FIG. 2C, the left half in the tube P is an optical fiber F1 on the light-emitting side, while the right half in the tube P is an optical fiber F2 on the light-receiving side. As shown in FIG. 2D, in the tube P, optical fibers F1 on the light-emitting side and optical fibers F2 on the light-receiving side are mixed. As shown in FIG. 2E, the central portion in the tube P is comprised of optical fibers F1 on the light-receiving (or light-emitting) side, while the peripheral portion in the tube P is comprised of optical fibers F2 on the light-receiving (or light-emitting) side.

The cooled mirror dew-point hygrometer 201 shown in FIG. 1 employs the tube P of a type shown in FIG. 2A as the tube 17. The tube 17 accommodates an optical fiber 17-1 on the light-emitting side and an optical fiber 17-2 on the light-receiving side. The optical fiber 17-1 on the light-emitting side and the optical fiber 17-2 on the light-receiving side have J-shaped curved portions. Distal end portions 101 and 102 of the optical fibers 17-1 and 17-2 on the light-emitting and light-receiving sides serve as light-emitting and light-receiving portions. The distal end portions 101 and 102 face the mirror surface 10-1 of the mirror and are inclined at a predetermined angle with respect to the mirror surface 10-1. As a result, the irradiation direction (optical axis) of the light from the optical fiber 17-1 is set parallel to the light-receiving direction (optical axis) of the light to the optical fiber 17-2. These optical fibers are adjacent to each other and inclined at the same inclination angle.

The control unit 201B comprises a dew-point temperature display unit 12, condensation sensor 13, Peltier output controller 14, signal converter 15, light reception amount increase detector 16A, and power supply unit 19. The dew-point temperature display unit 12 displays the temperature of the mirror 10 which is detected by the temperature detection element 11. The condensation sensor 13 obliquely applies pulse light at a predetermined period to the mirror surface 10-1 of the mirror 10 from the distal end portion 101 of the optical fiber 17-1. The condensation sensor 13 obtains as the intensity of reflected pulse light the difference between the upper and lower limit values of the reflected pulse light (scattered light) received through the optical fiber 17-2. The condensation sensor 13 sends a signal S1 corresponding to the intensity of the reflected pulse light to the Peltier output controller 14 and light reception amount abrupt increase detector 16A.

The light reception amount abrupt increase detector 16A receives the signal S1 corresponding to the reflected pulse light from the condensation sensor 13 and detects an abrupt increase in light reception amount of the scattered light upon irradiation from the distal end portion 101 of the optical fiber 17-1 to the mirror surface 10-1. The detector 16A supplies a reverse current flow instruction S4 to the Peltier output controller 14.

Upon reception of the signal S1 from the condensation sensor 13, the Peltier output controller 14 compares the intensity of the reflected pulse light with a predetermined threshold value th1. The Peltier output controller 14 outputs to the signal converter 15 a control signal S2 to increase the current to the thermoelectric cooling element 2 in accordance with the value of the signal S1 when the intensity of the reflected pulse light does not reach the threshold value th1, or a control signal S2 to decrease the current to the thermoelectric cooling element 2 in accordance with the value of the signal S1 when the intensity of the reflected pulse light exceeds the threshold value th1.

Upon reception of the reverse current flow instruction S4 from the light reception amount abrupt increase detector 16A, the Peltier output controller 14 interrupts control based on the signal S1 corresponding to the intensity of the reflected pulse light and received from the condensation sensor 13. The Peltier output controller 14 sends to the signal converter 15 a signal S2′ for forcibly switching the forward current to the thermoelectric cooling element 2 to a current value in the reverse direction. The signal converter 15 supplies to the thermoelectric cooling element 2 via the power supply unit 19 a current S3 or S3′ instructed by the control signal S2 or S2′ from the Peltier output controller 14.

[Measurement of Dew-Point Temperature]

In the cooled mirror dew-point hygrometer 201, the sensor unit 201A is placed in the measurement target gas.

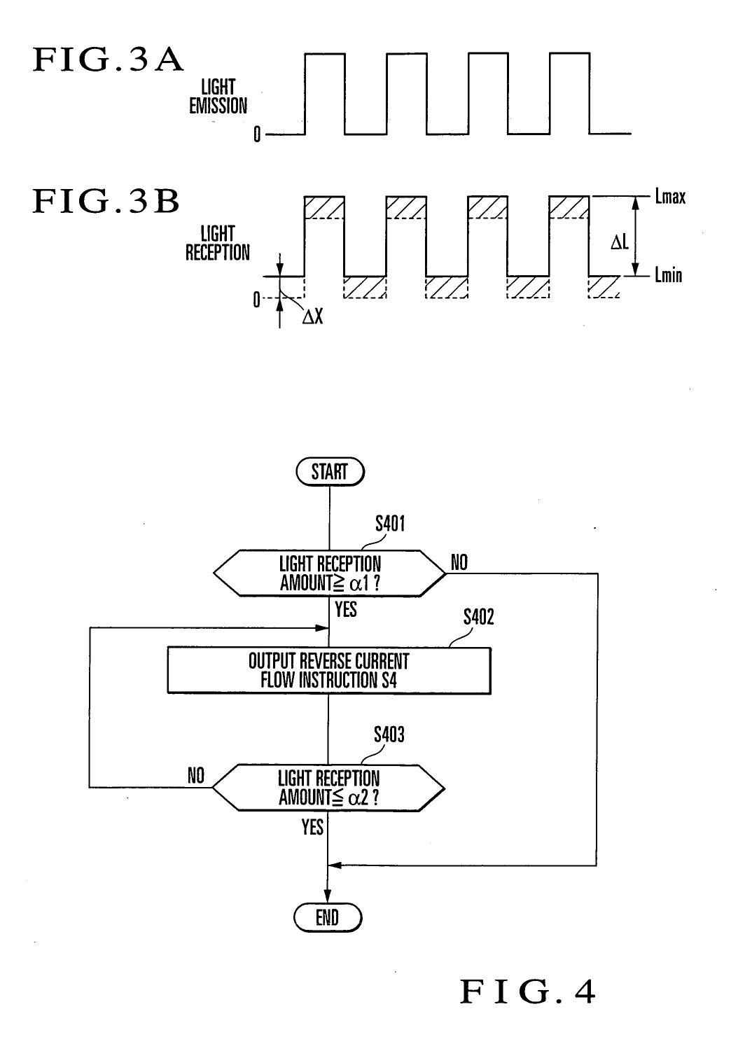

The condensation sensor 13 obliquely applies pulse light (FIG. 3A) at a predetermined period to the mirror surface 10-1 of the mirror 10 from the distal end portion 101 of the optical fiber 17-1. The mirror surface 10-1 is exposed to the measurement target gas. If no dew is formed on the mirror surface 10-1, almost all the pulse light emitted from the distal end portion 101 of the optical fiber 17-1 is regularly reflected. The amount of reflected pulse light (scattered light) from the mirror surface 10-1 and received through the optical fiber 17-2 is small. When no dew is formed on the mirror surface 10-1, the intensity of reflected pulse light received through the optical fiber 17-2 is low.

The condensation sensor 13 obtains as the intensity of reflected pulse light the difference between the upper and lower limit values of the reflected pulse light received through the optical fiber 17-2. The condensation sensor 13 sends the signal S1 corresponding to the intensity of the reflected pulse light to the Peltier output controller 14 and light reception amount abrupt increase detector 16A. In this case, the intensity of the reflected pulse light is almost zero and does not reach the threshold value th1. The Peltier output controller 14 sends to the signal converter 15 the control signal S2 to increase the current to the thermoelectric cooling element 2. The current S3 to be supplied to the thermoelectric cooling element 2 increases to lower the temperature of the cooling surface 2-1 of the thermoelectric cooling element 2.

When the temperature of the cooling surface 2-1 of the thermoelectric cooling element 2, i.e., the temperature of the mirror 10 decreases, the steam contained in the measurement target gas is condensed on the mirror surface 10-1 of the mirror 10. The water molecules partially absorbs or irregularly reflects the pulse light from the distal end portion 101 of the optical fiber 17-1. This makes it possible to increase the intensity of the reflected pulse light (scattered light) of the light from the mirror surface 10-1 through the optical fiber 17-2.

The condensation sensor 13 obtains the difference between the upper and lower limit values of each pulse of the received reflected pulse light. More specifically, as shown in FIG. 3B, a difference ΔL between an upper limit value Lmax and a lower limit value Lmin of each pulse of the reflected pulse light is calculated, as shown in FIG. 3B. The condensation sensor 13 defines ΔL as the intensity of the reflected pulse light. The processing in the condensation sensor 13 eliminates disturbance light ΔX from the reflected pulse light to prevent operation errors caused by the disturbance light. The processing scheme using the pulse light in the condensation sensor 13 for preventing operation error caused by the disturbance light is called a pulse modulation scheme. This processing makes it possible to eliminate the chamber from the sensor unit 201A in the cooled mirror dew-point hygrometer 201.

When the intensity of the reflected pulse light received through the optical fiber 17-2 exceeds the threshold value th1, the Peltier output controller 14 sends to the signal converter 15 the control signal to decrease the current to the thermoelectric cooling element 2. This allows to prevent a decrease in temperature of the cooling surface 2-1 of the thermoelectric cooling element 2 and hence prevent dew condensation. Suppression of dew condensation decreases the intensity of the reflected pulse light received through the optical fiber 17-2. When the intensity of the reflected pulse light becomes below the threshold value th1, the control signal S1 to increase the current to the thermoelectric cooling element 2 is sent from the Peltier output controller 14 to the signal converter 15. By repeating this operation, the temperature of the cooling surface 2-1 of the thermoelectric cooling element 2 is adjusted so that the intensity of the reflected pulse light received through the optical fiber 17-2 becomes almost equal to the threshold value th1. The adjusted temperature, i.e., the temperature at which dew condensation on the mirror 10-1 is set in an equilibrium state is displayed as the dew-point temperature on the dew-point temperature display unit 12.

In the cooled mirror dew-point hygrometer 201, the mounting portions of the optical fiber 17-1 on the light-emitting side and optical fiber 17-2 on the light-receiving side are integrated into one portion, thereby contributing to compactness of the detection unit 201A. Since the optical fiber 17-1 on the light-emitting side and the optical fiber 17-2 on the light-receiving side are accommodated in the tube 17, no alignment between the optical fiber 17-1 on the light-emitting side and the optical fiber 17-2 on the light-receiving side is required, improving operability in assembly.

In the cooled mirror dew-point hygrometer 201, the chamber can be eliminated from the sensor unit 201A, and a suction pump, suction tube, exhaust tube, and flowmeter can be eliminated. The number of components can be reduced, thereby further reducing the size of the sensor unit 201A. This makes it possible to improve operability in assembly and reduce the cost. Since the suction pump, suction tube, exhaust tube, and flowmeter need not be mounted, the hygrometer can be easily installed in a measurement area (measurement target gas). Since the suction pump, suction tube, exhaust tube, and flowmeter need not be mounted in the sensor unit 201A, the resultant hygrometer has two components, i.e., the sensor unit 201A and control unit 201B, and is thus portable.

[Abrupt Increase in Dew Point of Measurement target Gas during Measurement]

When the dew point of the measurement target gas increases during the above-described dew-point temperature measurement, the amount of condensation on the mirror surface 10-1 abruptly increases. The amount of scattered light from the mirror surface 10-1 upon irradiation from the distal end portion 101 of the optical fiber 17-1 abruptly increases. The amount of scattered light from the mirror surface 10-1 to the optical fiber 17-2 abruptly increases. The condensation sensor 13 obtains as the intensity of reflected pulse light the difference between the upper and lower limit values of the reflected pulse light received through the optical fiber 17-2. The condensation sensor 13 then sends the signal S1 corresponding to the intensity of the reflected pulse light to the light reception amount abrupt increase detector 16A. Upon reception of the signal S1 corresponding to the intensity of the reflected pulse light from the condensation sensor 13, the light reception amount abrupt increase detector 16A detects an abrupt increase (abrupt increase of dew point) of the intensity of the reflected pulse light and sends the reverse current flow instruction S4 to the Peltier output controller 14. In the first embodiment, the light reception amount abrupt increase detector 16A corresponds to a dew-point increase detection means of the present invention.

FIG. 4 shows processing for detecting an abrupt increase in intensity of reflected pulse light in the light reception amount abrupt increase detector 16A. The light reception amount abrupt increase detector 16A obtains the amount of received scattered light in accordance with the signal S1 corresponding to the intensity of the reflected pulse light from the condensation sensor 13. The light reception amount abrupt increase detector 16A compares the amount of received scattered light with a predetermined threshold value α1 (step S401).

When the amount of received scattered light is equal to or more than the threshold value α1 (YES in step S401), the light reception amount abrupt increase detector 16A determines an abrupt increase in the amount of received scattered light. The light reception amount abrupt increase detector 16A outputs the reverse current flow instruction S4 to the Peltier output controller 14 (step S402). The reverse current flow instruction S4 is kept supplied to the Peltier output controller 14 until the amount of received scattered light becomes equal to or less than a predetermined threshold value α2 (α2<α1) (YES in step S403).

In this embodiment, the threshold value α1 is set as a large value which cannot be taken by the amount of received scattered light in normal control based on the signal S2 from the Peltier output controller 14. The threshold value α2 is set as a value close to the amount of received scattered light at about the dew-point temperature.

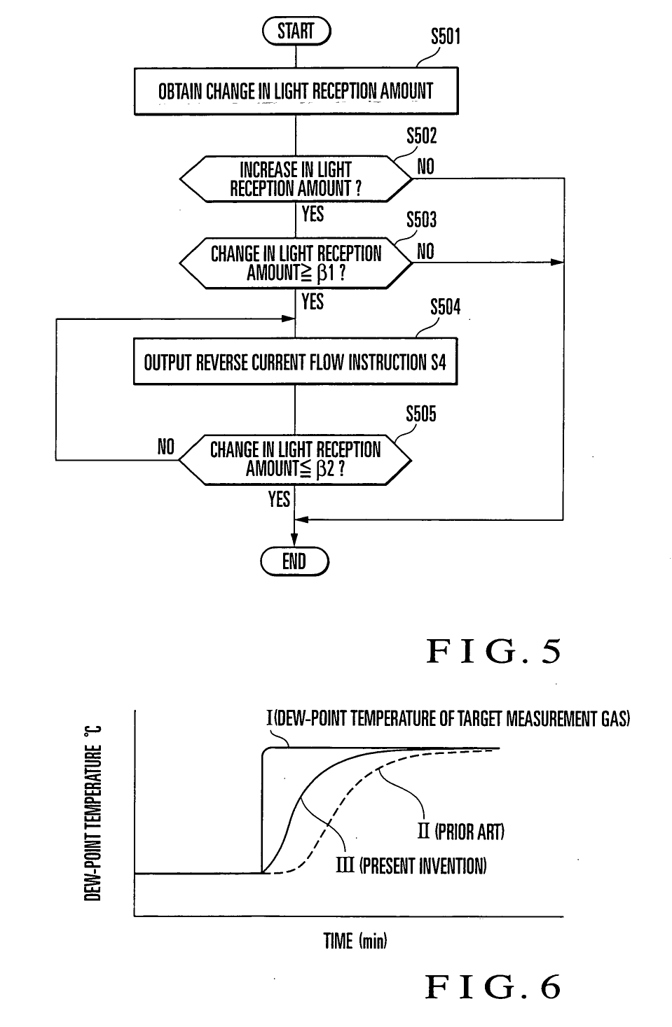

FIG. 5 shows another processing for detecting an abrupt increase in the intensity of the reflected pulse light in the light reception amount abrupt increase detector 16A. The light reception amount abrupt increase detector 16A obtains the amount of received scattered light from the signal S1 corresponding to the intensity of the reflected pulse light from the condensation sensor 13. The light reception amount abrupt increase detector 16A obtains as a change in light reception amount the difference between the current amount of received scattered light and that obtained a predetermined period of time before the current amount (step S501). The light reception amount abrupt increase detector 16A determines whether the change in light reception amount indicates an increase or decrease (step S502). If the change in light reception amount indicates an increase (YES in step S502), the change in light reception amount is compared with a predetermined threshold value β1 (step S503).

The increase in light reception amount is equal to or more than the threshold value β1 (YES in step S503), the light reception amount abrupt increase detector 16A determines an abrupt increase in the amount of received scattered light and outputs the reverse current flow instruction S4 to the Peltier output controller 14 (step S504). The reverse current flow instruction S4 is kept supplied to the Peltier output controller 14 until the increase in light reception amount becomes equal to or less than a predetermined threshold value β2 (β2<β1) (YES in step S505).

In this embodiment, the threshold value β1 is set as a large value which cannot be taken by the increase in light reception amount in normal control based on the signal S2 from the Peltier output controller 14. The threshold value β2 is set as a value close to zero.

Upon reception of the reverse current flow instruction S4 from the light reception amount abrupt increase detector 16A, the Peltier output controller 14 interrupts control based on the signal S1 corresponding to the intensity of reflected pulse light from the condensation sensor 13. The Peltier output controller 14 sends to the signal converter 15 the signal S2′ for forcibly switching the forward current to the thermoelectric cooling element 2 to a current value in the reverse direction. The signal converter 15 supplies to the thermoelectric cooling element 2 via the power supply unit 19 the current (reverse current) S3′ represented by the control signal S2′ from the Peltier output controller 14.

In the thermoelectric cooling element 2, the surface 2-1 serving as the low-temperature side is switched to the high-temperature side, while the surface 2-2 serving as the high-temperature side is switched to the low-temperature side. That is, the cooling surface and heating surface are switched. The mirror 10 is positively heated to quickly raise the temperature of the mirror surface. When the temperature of the mirror surface 10-1 almost reaches the dew-point temperature, the control signal S2′ from the Peltier output controller 14 is switched to S2, thereby restoring the normal control. As compared to the conventional case in which the current to the thermoelectric cooling element 2 is cut off, the waiting time until the dew-point temperature measurement can be greatly shortened.

FIG. 6 shows the mirror surface temperature when the dew point of the measurement target gas abruptly increases during the measurement. Referring to FIG. 6, a characteristic I represents a change in dew-point temperature of the measurement target gas; II, a change (prior art) in dew-point temperature when a current to the thermoelectric cooling element is cut off during an abrupt increase in dew point of the measurement target gas; and III, a change (present invention) in dew-point temperature when a reverse current flows in the thermoelectric cooling element during an abrupt increase in dew point of the measurement target gas. As can be apparent from the above graph, a response time in flowing the reverse current during the abrupt increase in dew point of the measurement target gas is shorter than that in the case wherein the current is cut off.

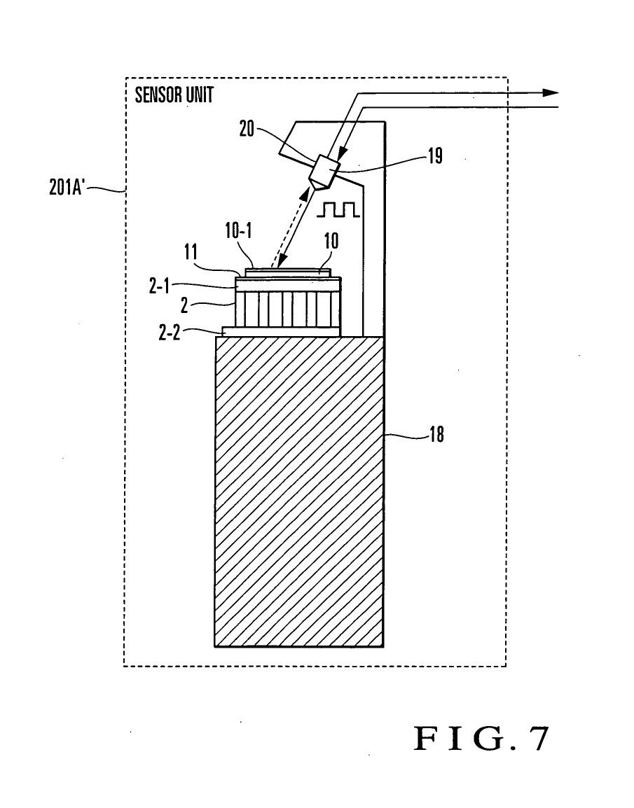

In the cooled mirror dew-point hygrometer 201 shown in FIG. 1, the tube 17 accommodating the optical fiber 17-1 on the light-emitting side and the optical fiber 17-2 on the light-receiving side is used. However, as shown in a sensor unit 201A′ shown in FIG. 7, a light-emitting diode 19 may be arranged in place of the optical fiber 17-1 on the light-emitting side, and a photocoupler 20 may be arranged in place of the optical fiber 17-2 on the light-receiving side.

### Second Embodiment: Regularly Reflected Light Detection Scheme

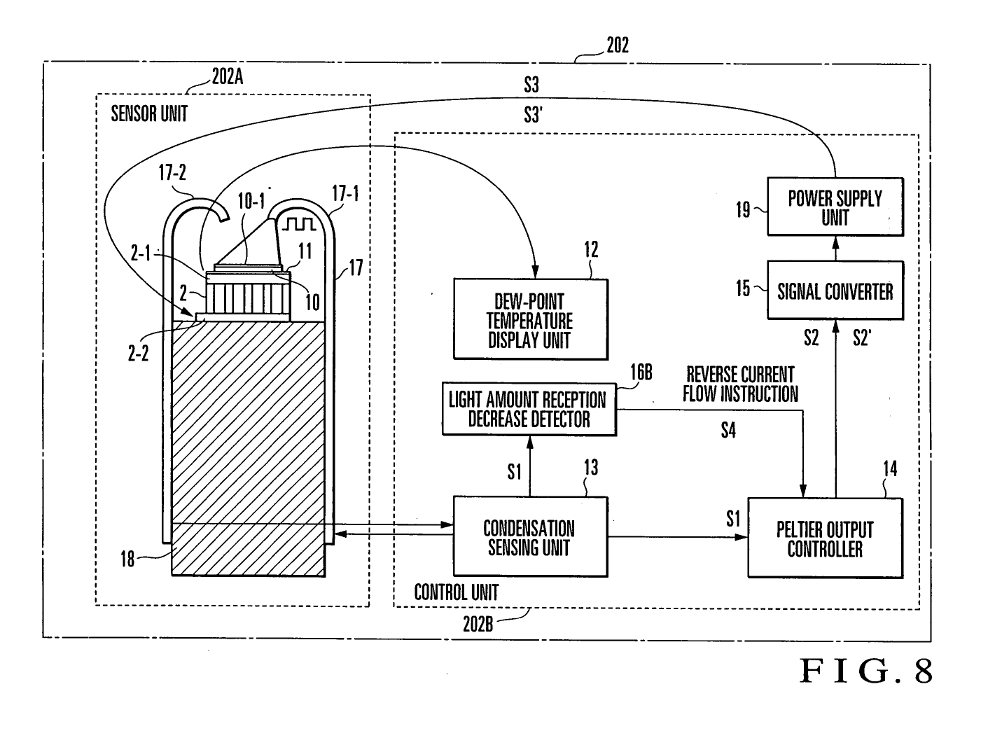

FIG. 8 shows the schematic arrangement of a cooled mirror dew-point hygrometer according to the second embodiment of the present invention. In a cooled mirror dew-point hygrometer 202, an optical fiber 17-1 on the light-emitting side and an optical fiber 17-2 on the light-receiving side are arranged not in the same direction, but symmetrically interposing a mirror 10 between the fibers 17-1 and 17-2. The optical fiber 17-1 on the light-emitting side and the optical fiber 17-2 on the light-receiving side have J-shaped curved portions. Distal end portions 101 and 102 of the curved portions face a mirror surface 10-1 of the mirror 10 and are inclined symmetrically at a predetermined inclination angle with respect to the mirror surface 10-1.

[Measurement of Dew-Point Temperature]

In the cooled mirror dew-point hygrometer 202, a sensor unit 202A is placed in the measurement target gas.

A condensation sensor 13 obliquely applies pulse light at a predetermined period to the mirror surface 10-1 of the mirror 10 from the distal end portion 101 of the optical fiber 17-1. The mirror surface 10-1 is exposed to the measurement target gas. If no dew is formed on the mirror surface 10-1, almost all the pulse light emitted from the distal end portion 101 of the optical fiber 17-1 is regularly reflected and received through the optical fiber 17-2. When no dew is formed on the mirror surface 10-1, the intensity of reflected pulse light (regularly reflected light) received through the optical fiber 17-2 is high.

The condensation sensor 13 obtains as the intensity of reflected pulse light the difference between the upper and lower limit values of the reflected pulse light received through the optical fiber 17-2. The condensation sensor 13 sends a signal S1 corresponding to the intensity of the reflected pulse light to a Peltier output controller 14 and light reception amount abrupt decrease detector 16B. In this case, the intensity of the reflected pulse light is high and exceeds a threshold value th2. The Peltier output controller 14 sends to a signal converter 15 a control signal S2 to increase the current to a thermoelectric cooling element 2. A current S3 to be supplied to the thermoelectric cooling element 2 increases to lower the temperature of a cooling surface 2-1 of the thermoelectric cooling element 2.

When the temperature of the cooling surface 2-1 of the thermoelectric cooling element 2, i.e., the temperature of the mirror 10 decreases, the steam contained in the measurement target gas is condensed on the mirror surface 10-1 of the mirror 10. The water molecules partially absorbs or irregularly reflects the pulse light from the distal end portion 101 of the optical fiber 17-1. This makes it possible to decrease the intensity of the reflected pulse light (regularly reflected light) of the light from the mirror surface 10-1 through the optical fiber 17-2.

When the intensity of the reflected pulse light received through the optical fiber 17-2 decreases below the threshold value th2, the Peltier output controller 14 sends to the signal converter 15 the control signal S2 to decrease the current to the thermoelectric cooling element 2. This allows to prevent a decrease in temperature of the cooling surface 2-1 of the thermoelectric cooling element 2 and hence prevent dew condensation. Suppression of dew condensation increases the intensity of the reflected pulse light received through the optical fiber 17-2. When the intensity of the reflected pulse light exceeds the threshold value th2, the control signal S2 to increase the current to the thermoelectric cooling element 2 is sent from the Peltier output controller 14 to the signal converter 15. By repeating this operation, the temperature of the cooling surface 2-1 of the thermoelectric cooling element 2 is adjusted so that the intensity of the reflected pulse light received through the optical fiber 17-2 becomes almost equal to the threshold value th2. The adjusted temperature, i.e., the temperature at which dew condensation on the mirror 10-1 is set in an equilibrium state is displayed as the dew-point temperature on a dew-point temperature display unit 12.

[Abrupt Increase in Dew Point of Measurement Target Gas During Measurement]

When the dew point of the measurement target gas increases during the above-described dew-point temperature measurement, the amount of condensation on the mirror surface 10-1 abruptly increases. The amount of regularly reflected light from the mirror surface 10-1 upon irradiation from the distal end portion 101 of the optical fiber 17-1 abruptly decreases. The amount of regularly reflected light from the mirror surface 10-1 to the optical fiber 17-2 abruptly decreases. The condensation sensor 13 obtains as the intensity of reflected pulse light the difference between the upper and lower limit values of the reflected pulse light received through the optical fiber 17-2. The condensation sensor 13 then sends the signal S1 corresponding to the intensity of the reflected pulse light to the light reception amount abrupt decrease detector 16B. Upon reception of the signal S1 corresponding to the intensity of the reflected pulse light from the condensation sensor 13, the light reception amount abrupt decrease detector 16B detects an abrupt decrease (abrupt increase of dew point) of the intensity of the reflected pulse light and sends a reverse current flow instruction S4 to the Peltier output controller 14. In the second embodiment, the light reception amount abrupt decrease detector 16B corresponds to a dew-point increase detection means of the present invention.

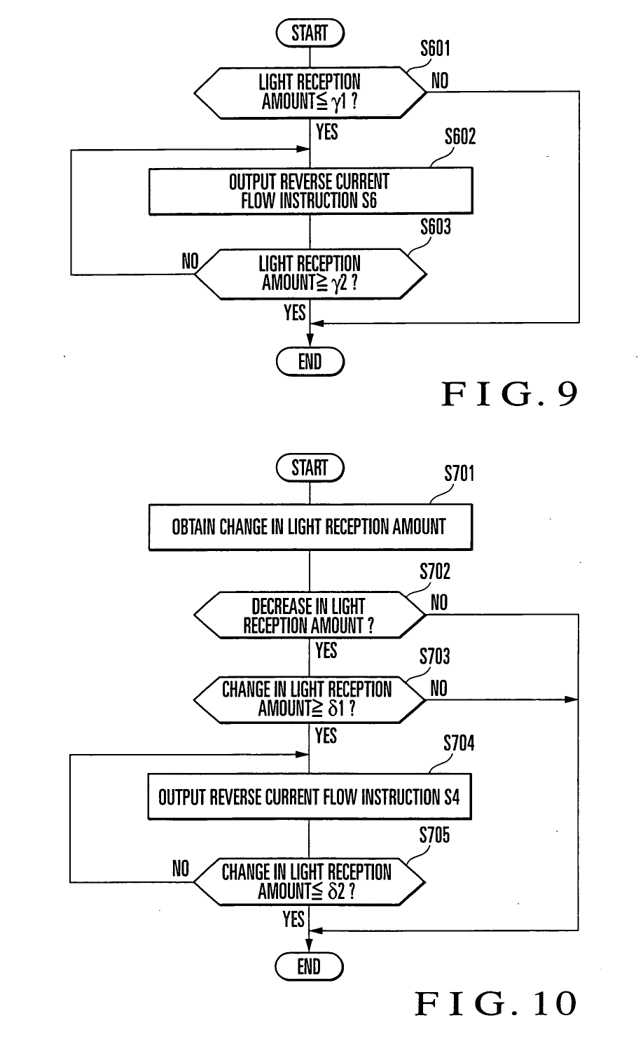

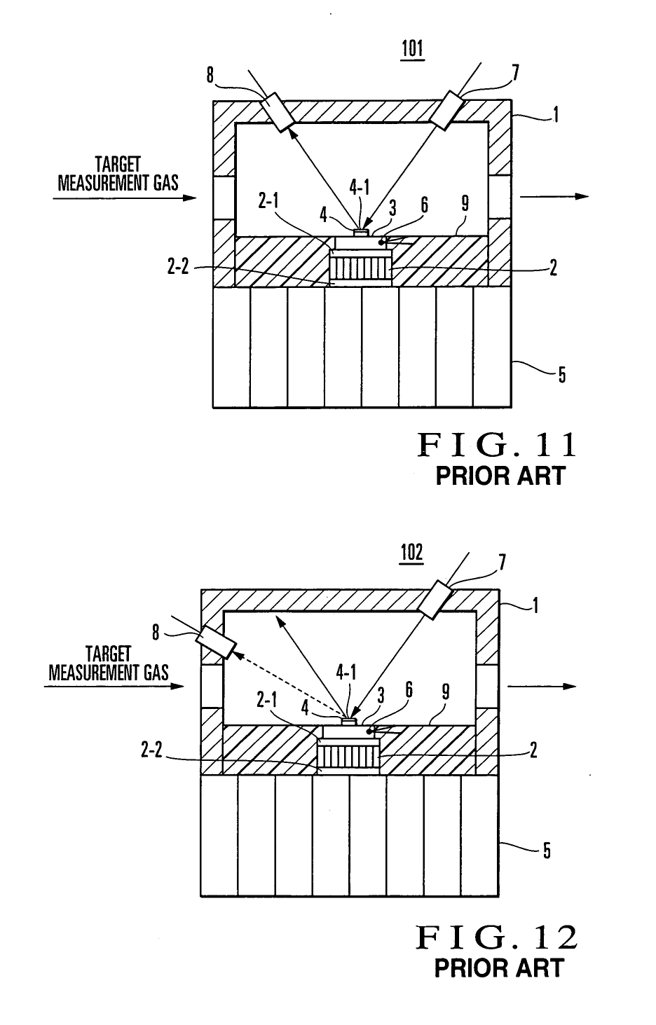

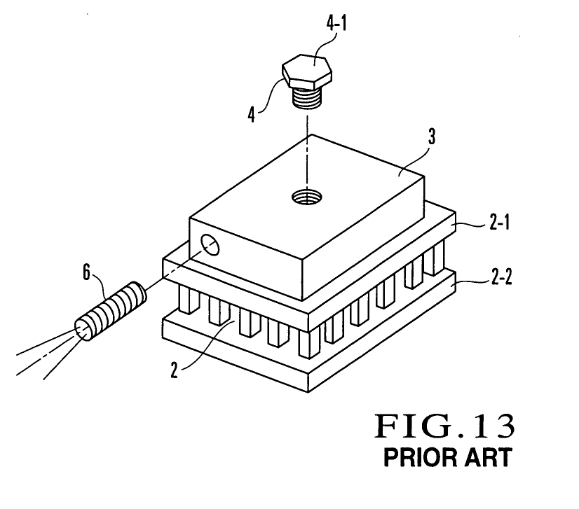

FIG. 9 shows processing for detecting an abrupt decrease in intensity of reflected pulse light in the light reception amount abrupt decrease detector 16B. The light reception amount abrupt decrease detector 16B obtains the amount of received regularly reflected light in accordance with the signal S1 corresponding to the intensity of the reflected pulse light from the condensation sensor 13. The light reception amount abrupt decrease detector 16B compares the amount of received regularly reflected light with a predetermined threshold value γ1 (step S601).

When the amount of received regularly reflected light is equal to or more than the threshold value γ1 (YES in step S601), the light reception amount abrupt decrease detector 16B determines an abrupt decrease in the amount of received regularly reflected light. The light reception amount abrupt decrease detector 16B outputs the reverse current flow instruction S4 to the Peltier output controller 14 (step S602). The reverse current flow instruction S4 is kept supplied to the Peltier output controller 14 until the amount of received regularly reflected light becomes equal to or more than a predetermined threshold value γ2 (γ2<γ1) (YES in step S603).

In this embodiment, the threshold value γ1 is set as a small value which cannot be taken by the amount of received regularly reflected light in normal control based on the signal S2 from the Peltier output controller 14. The threshold value y2 is set as a value close to the amount of received regularly reflected light at about the dew-point temperature.

FIG. 10 shows another processing for detecting an abrupt decrease in the intensity of the reflected pulse light in the light reception amount abrupt decrease detector 16B. The light reception amount abrupt decrease detector 16B obtains the amount of received regularly reflected light from the signal S1 corresponding to the intensity of the reflected pulse light from the condensation sensor 13. The light reception amount abrupt decrease detector 16B obtains as a change in light reception amount the difference between the current amount of received regularly reflected light and that obtained a predetermined period of time before the current amount (step S701). The light reception amount abrupt decrease detector 16B determines whether the change in light reception amount indicates an increase or decrease (step S702). If the change in light reception amount indicates a decrease (YES in step S702), the change in light reception amount is compared with a predetermined threshold value δ1 (step S703).

The decrease in light reception amount is equal to or more than the threshold value δ1 (YES in step S703), the light reception amount abrupt decrease detector 16B determines an abrupt decrease in the amount of received regularly reflected light and outputs the reverse current flow instruction S4 to the Peltier output controller 14 (step S704). The reverse current flow instruction S4 is kept supplied to the Peltier output controller 14 until the decrease in light reception amount becomes equal to or less than a predetermined threshold value δ2 (δ2<δ1) (YES in step S705).

In this embodiment, the threshold value δ1 is set as a large value which cannot be taken by the decrease in light reception amount in normal control based on the signal S2 from the Peltier output controller 14. The threshold value δ2 is set as a value close to zero.

Upon reception of the reverse current flow instruction S4 from the light reception amount abrupt decrease detector 16B, the Peltier output controller 14 interrupts control based on the signal S1 corresponding to the intensity of reflected pulse light from the condensation sensor 13. The Peltier output controller 14 sends to the signal converter 15 the signal S2′ for forcibly switching the forward current to the thermoelectric cooling element 2 to a current value in the reverse direction. The signal converter 15 supplies to the thermoelectric cooling element 2 via the power supply unit 19 the current (reverse current) S3′ represented by the control signal S2′ from the Peltier output controller 14.

In the thermoelectric cooling element 2, the surface 2-1 serving as the low-temperature side is switched to the high-temperature side, while the surface 2-2 serving as the high-temperature side is switched to the low-temperature side. That is, the cooling surface and heating surface are switched. The mirror 10 is positively heated to quickly lower the temperature of the mirror surface. When the temperature of the mirror surface 10-1 almost reaches the dew-point temperature, the control signal S2′ from the Peltier output controller 14 is switched to S2, thereby restoring the normal control. As compared to the conventional case in which the current to the thermoelectric cooling element 2 is cut off, the waiting time until the dew-point temperature measurement can be greatly shortened.

Note that the current value of the current (reverse current) S3′ represented by the control signal S2′ may be a predetermined arbitrary value or the same value (but in reverse flow direction) as the current S3 flowing immediately before the designation by the control signal S2′.

According to the present invention, when the dew-point of the measurement target gas abruptly increases during dew-point temperature measurement, a current is forcibly flowed to the thermoelectric cooling element in the reverse direction. The surface serving as the low-temperature side is switched to the high-temperature side, while the surface serving as the high-temperature side is switched to the low-temperature side. The mirror is positively heated to quickly increase the mirror temperature, thereby greatly shortening the waiting time until the dew-point temperature measurement.

What is claimed is:

1. A cooled mirror dew-point hygrometer comprising:
a thermoelectric cooling element having one surface set as a low-temperature side and the other surface set as a high-temperature side upon reception of a current in a positive direction;
a mirror mounted on said one surface of said thermoelectric cooling element and having a mirror surface exposed to a measurement target gas;
light-emitting means for applying light to said mirror surface;
light-receiving means for receiving one of scattered light and regularly reflected light of light emitted from said light-emitting means to said mirror surface;
temperature detection means for detecting a temperature of said mirror surface;
dew-point increase detection means for detecting a rise of a dew point of the measurement target gas; and
control means for controlling the current supplied to said thermoelectric cooling element in the positive direction so as to set an equilibrium state having no increase/decrease in dew condensation on said mirror surface, on the basis of a light reception amount of one of the scattered light and regularly reflected light received by said light-receiving means,
wherein said control means forcibly supplies a current to said thermoelectric cooling element in a direction reverse to the positive direction when said dew-point increase detection means detects a rise in dew point.

2. A hygrometer according to claim 1, wherein said dew-point increase detection means detects a rise in dew point when the light reception amount of the scattered light received by said light-receiving means exceeds a predetermined threshold value.

3. A hygrometer according to claim 1, wherein said dew-point increase detection means detects a rise in dew point when an increase in light reception amount of the scattered light received by said light-receiving means exceeds a predetermined threshold value.

4. A hygrometer according to claim 1, wherein said dew-point increase detection means detects a rise in dew point when the light reception amount of the regularly reflected light received by said light-receiving means decreases below a predetermined threshold value.

5. A hygrometer according to claim 1, wherein said dew-point increase detection means detects a rise in dew point when an increase in light reception amount of the regularly reflected light received by said light-receiving means decreases below a predetermined threshold value.

6. A hygrometer according to claim 1, wherein
said light-receiving means comprises a distal end portion of a first optical fiber,
said light-receiving means comprises a distal end portion of a second optical fiber adjacent to said first optical fiber and having an optical axis parallel to that of said first optical fiber, and
said distal end portions of said first optical fiber and said second optical fiber are open on the same plane.

7. A hygrometer according to claim 6, wherein the optical axes of said first optical fiber and said second optical fiber in an irradiation direction and a light-receiving direction have the same inclination angle with respect to said mirror surface of said mirror.

8. A hygrometer according to claim 7, further comprising condensation sensing means for obtaining as an intensity of received pulse light a difference between an upper limit value and a lower limit value of one of scattered pulse light and regularly reflected pulse light received by said second optical fiber when pulse light is obliquely applied at a predetermined period to said mirror surface of said mirror from said distal end portion of said first optical fiber,
wherein said dew-point increase detection means detects a rise in dew point of the measurement target gas on the basis of an intensity of received pulse light output form said condensation sensing means.

9. A hygrometer according to claim 8, wherein said control means controls a current to said thermoelectric cooling element on the basis of an intensity of received pulse light output from said condensation sensing means.
